(19) United States
(12) Patent Application Publication
(10) Pub. No.: US 2011/0210741 A1
(43) Pub. Date: Sep. 1, 2011

(54) Structure for magnetic field sensor for marine geophysical sensor streamer

(76) Inventors: Gustav Göran Mattias Südow, Vallingby (SE); Ulf Peter Lindqvist, Segeltorp (SE); Andras Robert Juhasz, Hagersten (SE)

(21) Appl. No.: 12/660,538

(22) Filed: Mar. 1, 2010

(51) Int. Cl. G01V 3/00

(52) U.S. Cl. 324/332

(57) ABSTRACT

A marine electromagnetic sensor cable includes a first jacket covering an exterior of the cable. At least one wire loop is disposed on the exterior of the first jacket. The wire loop is shaped to have a magnetic dipole moment along a selected direction. A contact ring is disposed inside the first jacket to make electrical connection between the at least one wire loop and an associated signal processing circuit disposed inside the first jacket.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention is related to systems and methods for estimating the response of rock formations in the earth's subsurface to imparted electromagnetic fields in order to determine spatial distribution of electrical properties of the rock formations. More particularly, the invention is related to methods for reducing induction noise caused by sensor movement in a towed marine electromagnetic survey system.

2. Background Art

U.S. Patent Application Publication No. 2010/0017133, a patent application owned by an affiliated company of the owner of the present invention, describes structures and methods for detecting voltages induced in a towed marine geophysical sensor. Generally, the disclosed method includes measuring a parameter related to an amount of current passed through an electromagnetic transmitter to induce an electromagnetic field in subsurface formations. A magnetic field proximate the electromagnetic receiver is measured. A transmitter portion of the measured magnetic field is estimated from the measured parameter. A motion portion of the measured magnetic field is estimated from the measured magnetic field and the estimated transmitter portion. A voltage induced in the receiver is estimated from the estimated motion portion. Signals detected by the receiver are corrected using the estimated voltage.

Generally, the disclosed method is based on the assumption that the total magnetic field, represented by H(t), of the Earth, as experienced in the water at each of the receivers is essentially uniform in space, that is, the Earth's magnetic field does not vary significantly over the length of the receiver cable, although it does vary with time due to magnetotelluric effects. The receiver cable is composed of electrical conductors moving within the Earth's magnetic field H(t) with a determinable velocity v(t). Assuming that the spatial distribution of the receiver cable changes slowly with respect to time, v(t) will be a slowly varying function. The Earth magnetic field induced voltage noise at each receiver is proportional to the rate of change of magnetic flux, which is proportional to the product of the Earth's magnetic field H(t) and the component of the receiver cable velocity vector that is perpendicular to the Earth's magnetic field. The '133 publication discloses a number of structures for magnetic field sensors in the receiver cable. All the disclosed structures are inside the structure of the receiver cable, which makes them susceptible to movement as the cable bends and twists during survey operations. There is a need for improved structures for magnetic field sensors in such receiver cables that are less susceptible to effects of cable deformation during survey operations.

### SUMMARY OF THE INVENTION

A marine electromagnetic sensor cable according to one aspect of the invention includes a first jacket covering an exterior of the cable. At least one wire loop is disposed on the exterior of the first jacket. The wire loop is shaped to have a magnetic dipole moment along a selected direction. A contact ring is disposed inside the first jacket to make electrical connection between the at least one wire loop and an associated signal processing circuit disposed inside the first jacket.

Other aspects and advantages of the invention will be apparent from the following description and the appended claims.

### BRIEF DESCRIPTION OF THE DRAWINGS

FIG. 1 is an example electromagnetic survey system.

FIG. 2 shows the receiver cable of the system in FIG. 1 in more detail.

FIG. 3 shows magnetic field sensors disposed at selected locations along the receiver cable in FIG. 2.

FIG. 4 shows magnetic field sensors in more detail.

FIG. 5 shows an example of lateral deflections in the wire of coils forming the magnetic field sensors in FIG. 4.

FIG. 6 shows an alternative coil arrangement for the sensors of FIG. 4.

### DETAILED DESCRIPTION

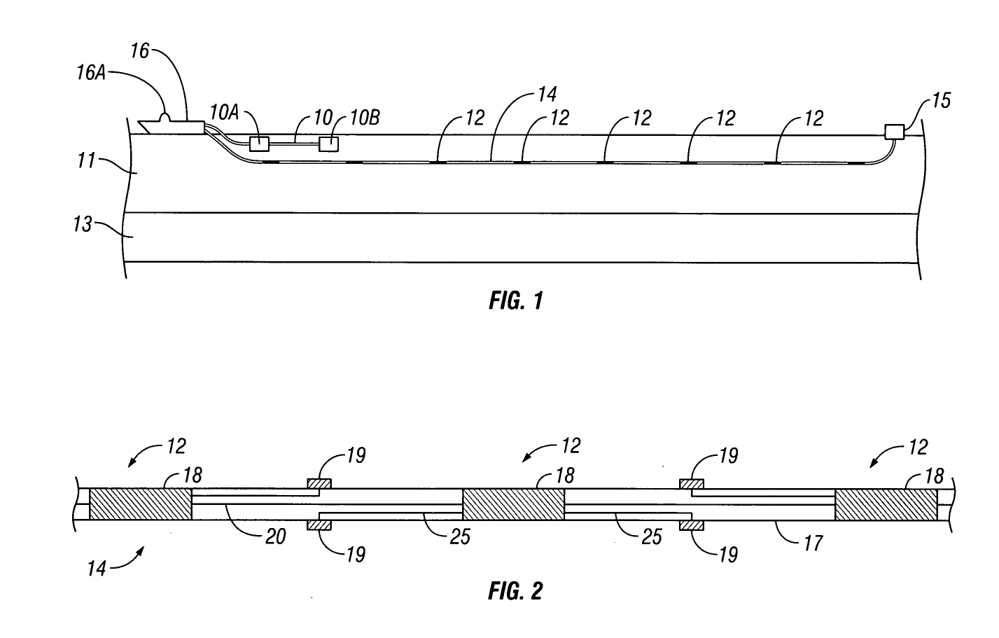

FIG. 1 shows an example of a marine electromagnetic survey system that may be made according to the invention. In the system shown in FIG. 1, an electromagnetic transmitter cable 10 and a plurality of receivers 12 disposed within a receiver cable 14 are towed behind a survey vessel 16 along a body of water 11 such as a lake or the ocean. The transmitter 10 may be, for example, an electrode bi-pole, including two spaced apart electrodes 10A, 10B along an insulated, reinforced electrical cable. The transmitter could also be a magnetic field source such as one or more wire loops (not shown). Equipment disposed on the vessel 16, shown generally at 16A and referred to for convenience as a “recording system” may include circuits (not shown separately) arranged to pass electric current through the transmitter 10, e.g., the electrodes 10A, 10B, at selected times. The current may have any transient-type waveform, including, for example, switching direct current on, switching direct current off, changing direct current polarity, or switching current in a pseudo-random binary sequence. The transmitter current may also be continuous wave having one or more discrete frequencies. Other circuits (not shown) in the recording system 16A may detect voltages induced in the various receivers 12 on the receiver cable 14 and can make a recording with respect to time of the voltages induced in each receiver 12. Typically such recordings will be indexed with respect to particular events in the transmitter current waveform. Electromagnetic fields produced by passing the current through the transmitter 10 travel through the water 11, and through formations 13 below the water bottom. Electromagnetic fields induced in response are detected by the receivers 12 on the receiver cable 14. The various signals detected by the receivers 12 may be interpreted to infer the spatial distribution of electrical conductivity in the formations 13.

A portion of the receiver cable 14 may be observed in more detail in FIG. 2. The receiver cable 14 has a flexible outer jacket 17, made from material such as polyurethane. The jacket 17 may be filled with non-conducting liquid such as oil or kerosene, or, preferably, with a gel-like material such as is known in the art to be used to fill certain types of marine seismic streamers. Each receiver 12 may include a signal processing module 18 and may be configured to measure a voltage imparted across spaced apart pairs of electrodes 19 coupled to the module 18 as shown. Alternatively, the receivers 12 may be configured to measure voltage induced in one or more wire loops or magnetometers (not shown) for measuring magnetic field and/or the time derivative of the magnetic field. The electrodes 19 (or magnetic field sensing devices) may be coupled to the respective signal processing modules using electrode cables 25. A power and communications cable 20 may provide electrical power such as from the recording system (16A in FIG. 1) for powering the various circuits in the signal processing modules 18 and providing a communications path to transfer signals representing the receiver measurements to a remote location, such as the recording system (16A in FIG. 1). It is contemplated that the signal processing modules 18 will include suitable preamplification and signal conditioning devices (not shown) and may include devices (not shown) for converting analog voltage measurements into digital signals for communication along the communications cable 20, however, the foregoing are not intended to limit the scope of the invention. The signal processing modules 18 and associated electrodes 19 may be arranged as shown in FIG. 2 so that the electrodes 19 from adjacent modules 18 are in the same axial position along the receiver cable 14, however, such arrangement is not a limit on the scope of this invention. Other items typically associated with such as receiver cable not shown for clarity of the illustration include strength members such as made from fiber rope, to transfer axial strain along the cable 14.

The example transmitter and receivers shown in FIGS. 1 and 2 are horizontal electric bi-poles. As explained above, magnetic field sensing devices and transmitters may also be used in electromagnetic surveying according to the invention. It should also be understood that vertical bi-poles may be used in accordance with the invention.

As explained in the Ziolkowski et al. patent application publication referred to in the Background section herein, in order to reduce the effects of the induced voltage noise from the Earth's magnetic field in a moving electromagnetic receiver 12, three principal time-varying quantities can be measured: a parameter related to the current I(t) applied to the transmitter (10 in FIG. 1), the voltage V(t) measured at the receiver 12, and three orthogonal components of the induced magnetic field HIₓ(t), HI_{y}(t), and HI_{z}(t) at one or more positions along the receiver cable (14 in FIG. 1). The transmitter current I(t) should be measured as closely to the transmitter (10 in FIG. 1) as possible. Such measurement can be performed using any suitable device, for example a magnetometer, which can measure the magnetic field induced by the transmitter.

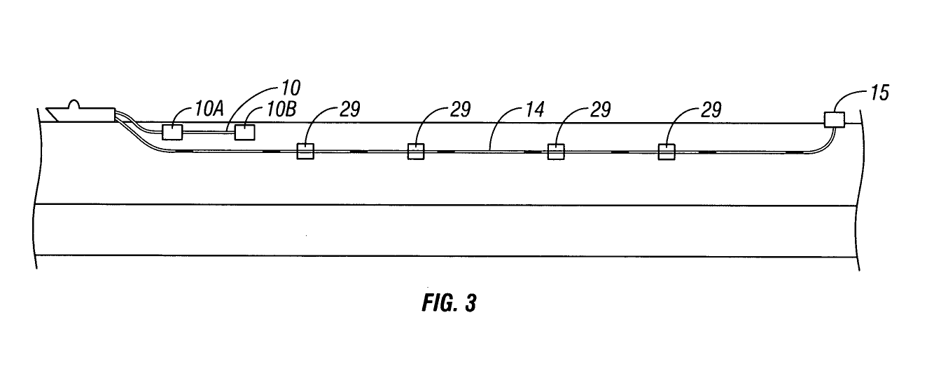

FIG. 3 shows a type of a receiver cable 14 in the system of FIG. 1 in which magnetic field sensors 29 may be disposed along the receiver cable 14 at selected positions to measure the three induced magnetic field components. The present invention is related to improved structures for such magnetic field sensors compared to those disclosed in the Ziolkowski et al. publication.

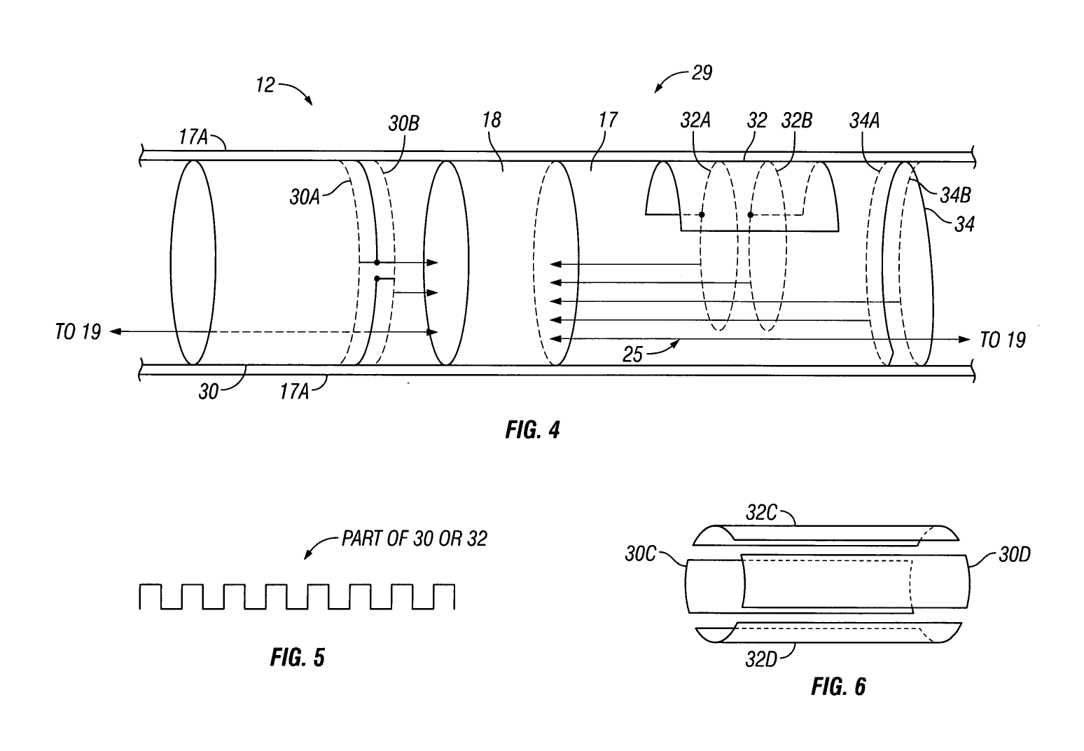

FIG. 4 shows an example structure of a magnetic field sensor 29 according to the invention. A first wire loop or coil 30 may be disposed on the exterior surface of the jacket 17, generally in the area of one of the signal processing modules 18. The first wire loop 30 may be a so called “saddle coil” which has a magnetic dipole moment perpendicular to the cross sectional area of the first loop 30. The first loop 30 may cover up to 180 degrees of the circumference of the jacket 17 in the manner shown in FIG. 4 so that the dipole moment of the first loop 30 is transverse to the longitudinal axis of the cable 14. A second saddle coil 32 may also be positioned on the exterior of the jacket 17, and may be oriented so that its magnetic dipole moment is orthogonal to that of the first loop 30. A third coil 34 may be disposed on the exterior of the jacket and wound in a plane perpendicular to the longitudinal axis of the receiver cable 14, thus having a dipole moment along the cable 14. Each of the loops 30, 32 and coil 34 may be electrically connected to the signal processing module 18 using conductor rings 30A, 30B, 32A, 32B, 34A, 34B, respectively, disposed inside the jacket 17. The conductor rings may be, for example, stainless steel bands to maintain the shape of the cable 14. The loops 30, 32 and coil 34 may be protected by affixing a second jacket 17A over the exterior of the loops 30, 32 and coil 34 and the jacket 17. The second jacket 17A may also be made from polyurethane or similar material.

FIG. 5 shows an example of how any of all of the loops or coils (e.g., 30 in FIG. 4) may be configured to enable measurement of strain along the exterior surface of the receiver cable 14. The wire forming the loop 30 may be shaped to have small scale lateral displacements from the general path of the wire, such as square or rectangular shapes as shown in FIG. 5. It is contemplated that a suitable size for the lateral displacements is on the order of 1 millimeter. However, the size may be any size that enable detection of strain (explained below) and will resist breakage of the wire under the maximum expected strain on the receiver cable 14. Such a wire configuration will change electrical resistance as the receiver cable bends, twists or elongates. Such change in resistance may be measured in the signal processing module (18 in FIG. 4) for example, and the measurements thereof converted (e.g., in the recording system 16A) to amounts of axial, torsional and/or bending strain in the receiver cable 14.

The wire loops or coils described above may be molded into the jacket 17 during extrusion or other manufacturing process. Alternatively, the wire loops or coils may be deposited on the surface of the jacket by spraying powdered, electrically conductive material such as powdered metal dispersed in a suitable binder onto the exterior of the jacket 17. In such configuration, electrical contact may be made between the coil and the conductor rings by piercing the jacket 17 where the end of the loop or coil is disposed at the location of the conductor ring with a suitable length metal pin.

If it is desirable to conserve length along the exterior of the cable 14 when applying the magnetic field sensors, the saddle coils (30, 32 in FIG. 4) may be each configured into two saddle coils disposed on opposite sides of the jacket (17 in FIG. 4) electrically connected in inverted series, wherein each saddle coil covers at most about one-fourth the circumference of the exterior of the cable (14 in FIG. 1). Referring to FIG. 6, a first pair of opposed saddle coils 30C, 30D performs the same magnetic field detection as does the first saddle coil (30 in FIG. 4), wherein the magnetic dipole is substantially transverse to the longitudinal axis of the cable (14 in FIG. 1). A second pair of opposed saddle coils 32C, 32D performs the same magnetic field detection function as does the second saddle coil (32 in FIG. 4), wherein the magnetic dipole of the second coil pair 32C, 32D is substantially orthogonal to that of the first saddle coil pair, and is substantially transverse to the longitudinal axis of the cable (14 in FIG. 1).

A receiver cable made according to the various aspects of the invention may have improved detection of induced voltages caused by moving the cable through the earth's magnetic field. Such cables in some embodiments may also be able to detect bending, twisting and axial strain in the cable.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A marine electromagnetic receiver cable, comprising:
a first jacket covering an exterior of the cable;
at least one wire loop disposed on the exterior of the first jacket, the wire loop shaped to have a magnetic dipole moment along a selected direction; and
a conductor ring disposed inside the first, jacket to make electrical connection between the at least one wire loop and an associated signal processing circuit disposed inside the first jacket.

2. The cable of claim 1 wherein the at least one wire loop is saddle shaped and covers at most half a circumference of the first jacket.

3. The cable claim 2 wherein the at least one wire loop includes two saddle shaped coils disposed on opposed sides of the first jacket.

4. The cable of claim 3 further comprising two additional saddle coils disposed on opposed sides of the first jacket, the two additional saddle coils longitudinally aligned with the two saddle shaped coils and disposed orthogonally to the two saddle shaped coils.

5. The cable of claim 1 further comprising a second jacket disposed externally to the first jacket and the at least one wire loop.

6. The cable of claim 1 further comprising at least one set of three wire loops disposed on the exterior of the first jacket such that each wire loop has a magnetic dipole moment mutually orthogonal to the other wire loops in the set.

7. The cable of claim 1 wherein the wire in the at least one loop includes lateral displacements from the path of the wire, the lateral displacements having size and shape selected to cause change in resistance of the wire as a result of strain along the path of the wire; the lateral displacements haying size selected to resist tearing of the wire under a maximum expected strain on the cable.

8. The cable of claim 1 further comprising at least one electromagnetic field sensor responsive to electromagnetic fields emanating from subsurface rock formations in response to an electromagnetic field imparted thereto by a transmitter.

9. The cable of claim 8 wherein the at least one electromagnetic field sensor comprises a pair of spaced apart electrodes disposed externally to the second jacket.

10. The cable of claim 9 wherein the electrodes are coupled to a signal processing device disposed inside the first jacket.

11. The cable of claim 1 wherein the at least one wire loop is molded into the first jacket dining manufacture thereof.

12. The cable of claim 1 wherein the at least one wire loop is deposited on the first jacket in the form of electrically conductive particles suspended in a binder.

13. The cable of claim 1 wherein the jacket is filled with at least one material selected from the group consisting of: a non-conducting liquid, an oil, a kerosene, a gel-like material, and any combination thereof.
